(19) United States
(12) Patent Application Publication
(10) Pub. No.: US 2016/0184186 A1
(43) Pub. Date: Jun. 30, 2016

(54) DOUBLE ENDED INFANT SOOTHING DEVICE

(71) Applicants: MyNhi Montini, East Haven, CT (US); Nichols Montini, East Haven, CT (US)

(72) Inventors: MyNhi Montini, East Haven, CT (US); Nichols Montini, East Haven, CT (US)

(21) Appl. No.: 14/587,520

(22) Filed: Dec. 31, 2014

(51) Int. Cl. A61J 17/00; A61J 17/02

(52) U.S. Cl. CPC A61J 17/001; A61J 17/02

(57) ABSTRACT

A double ended infant soothing device to relive the pain and discomfort experienced by the infant while teething. The double ended infant soothing device comprises a handle extending between a pair of ends, where the handle includes a cover; a removable pacifier attached at each end, where the pacifier includes a base and a nipple; and at least one removable teething ring attached at each end, positioned between the pacifier and the end, where the teething ring includes angular sides to prevent the double ended infant soothing device form rolling.

### BACKGROUND OF THE INVENTION

1. Field of the Invention

The present invention relates to a pacifier with a mouthpiece at each end. The pacifier further included teething rings at each end to occupy and stimulate the infant as they handle the device.

2. Description of Related Art

It can be very heart wrenching and aggravating as a parent when failing to sooth a crying, screaming infant while they are teething. The teething infant is understandably frustrated, because the process of cutting a tooth is his or her first experience with chronic pain. All the infant seeks is relief. Unfortunately, there is nothing that can be done to completely alleviate the baby's discomfort, but parents and guardian have developed tools and remedies to ease the pain.

Teething toys are a great distraction for the infant because it gives them something to occupy their hands and an object to chew on. The act of chewing helps because it provides counter pressure to the gums. Sadly, after just a short period of time the infant loses interest in the teether and starts crying again. Also, the part that the baby holds onto is the same part that goes into the baby's mouth, and the same parts that rest on the underlying surfaces. Germs, dirt, bacteria and filth are then easily transferred into the baby's mouth, which can cause colds and illnesses. Not an ideal circumstance when dealing with an already fussy baby.

Based on the above cited problems, it would be beneficial in the art to provide a soother device that stimulates the child with various features so they are occupied for more than a brief period of time. It would also be desirable in the art to provide a soother device that may be cleaned or parts exchanged to prevent the infant from being repeatedly exposed to unhealthy germs and bacteria.

### SUMMARY OF THE INVENTION

In view of the foregoing disadvantages inherent in the prior art, the general purpose of the present invention is to provide a double ended infant soothing device to comfort and relieve pain causing by teething, configured to include all of the advantages of the prior art, and to overcome the drawbacks inherent therein.

Accordingly, an object of the present invention is to provide a double ended infant soothing device with a pacifier at each end to allow the baby to suckle from any direction.

Another object of the present invention is to provide a double ended infant soothing device with teething rings positioned next to the pacifiers. The teething rings are removable so they may be cleaned as desired by the parent or guardian.

To achieve the above objects, in an aspect of the present invention, a double ended infant soothing device is described comprising a handle extending between a pair of ends, where the handle includes a cover; a removable pacifier attached at each end, where the pacifier includes a base and a nipple; and at least one removable teething ring attached at each end, positioned between the pacifier and the end, where the teething ring includes angular sides to prevent the double ended infant soothing device form rolling.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a double ended infant soothing device in accordance with an exemplary embodiment of the present invention; and

FIG. 2 depicts a front view of a teething ring in accordance with an exemplary embodiment of the present invention.

Like reference numerals refer to like parts throughout the description of several views of the drawings.

### DETAILED DESCRIPTION OF THE DRAWINGS

The present invention relates to a pacifier with a mouthpiece at each end. The pacifier further included teething rings at each end to occupy and stimulate the infant as they handle the device. The present invention provides a double ended infant soothing device to facilitate the process of providing remedial care for teething babies. The double ended infant soothing device includes a handle with a pacifier attached at each end. Between the pacifier and the handle are a set of teething rings which are removable for cleaning By replacing the standard teething toys with the double ended infant soothing device the child is provided with a stimulating toy that allows for cleaning and sanitation between every use.

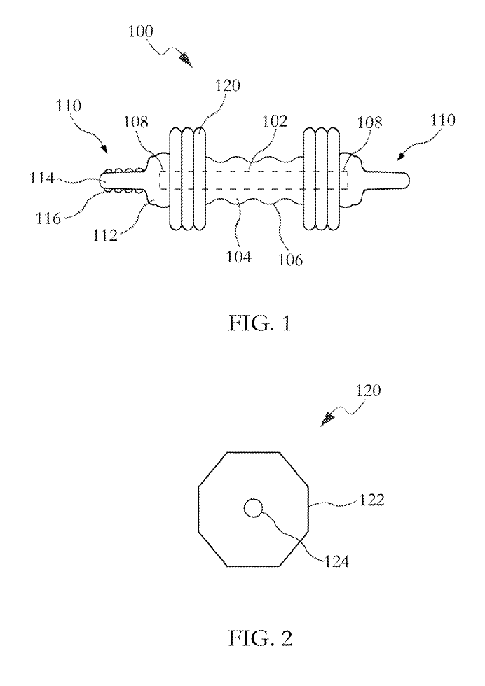

Turning now descriptively to the drawings, referring to FIG. 1, a perspective view of a double ended infant soothing device 100 is shown in accordance with an exemplary embodiment of the present invention. The double ended infant soothing device 100 includes a handle 102 extending between a pair of ends 108. The handle 102 may include a cover 104 with a set of finger indentions 106 for an ergonomic grip against an infant's hand. The cover 104 may be made from rubber, plastic, neoprene, silicone, nylon or the like. The handle 102 and cover 104 may be approximately the width of a finger for easy grasping and holding in the infant's hand.

At each end 108 of the handle 102 is a pacifier 110. Each pacifier 110 includes a wide base 112 and a nipple 114 for chewing and sucking by the infant. The nipples 114 may be covered with bumps 116 or texture for greater gum stimulation and ease. Additionally, the nipples 114 may be elongated to allow chewing by the molars thereby relieving pain on the back gums. The pacifier 110 may snap on or screw on to each end 108 of the handle 102 so that it is secure during handling, yet easy for a parent or guardian to remove. The pacifier 110 may be made from rubber, plastic or silicone.

Between each pacifier 110 and end 108 are a plurality of teething rings 120 which may serve as bumpers or stoppers to prevent the infant from placing the handle 102 in their mouth. This will prevent the baby from gagging or choking while chewing the soothing device 100. The teething rings 120 may be stacked 1-4 deep next to each other and easily removed as desired. The teething rings 120 may shaped with angular sides 122 to prevent the double ended infant soothing device 100 from rolling when placed on a surface. As illustrated in FIG. 2, the teething ring 120 is shaped as an octagon with eight sides 122. Alternatively, the teething ring 120 may be shaped as a triangle, square, pentagon, hexagon, heptagon, nonagon or decagon, thus ranging in sides from 3-10. In the middle of the teething ring 120 is a hole 124 through which the end 108 of the handle 102 is inserted to attach to the pacifier 110. The teething ring 120 may be made from rubber, plastic, silicone, wood and the like. The teething rings 120 may be liquid filled so that they may be frozen. Cold and frozen teething toys help to numb the baby's guns thereby relieving the pain and discomfort experienced while teething.

With the double ended infant soothing device 100 the infant is able to diminish their aggravation endured from aching gums. The handle 102 is ergonomically shaped to fit into the infant's palm like a finger, and with the indentions 106 the infant will not lose their grip. The pacifier 110 combined with the teething rings 120 provides multiple surfaces for the baby to chew that they are repeatedly stimulated and interested in the device 100. The materials making the cover, pacifier and teething rings may be flavored or scented for additional appeal and enjoyment by the infant. Since the pacifier 110 and the teething ring 120 are removable from the handle 102 each individual piece may be cleaned and sanitized as needed or desired therefore ensuring that the device 100 remains clean and free of harmful germs, dirt and debris.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A double ended infant soothing device comprising:
a. a handle extending between a pair of ends, where the handle includes a cover;
b. a removable pacifier attached at each end, where the pacifier includes a base and a nipple; and
c. at least one removable teething ring attached at each end, positioned between the pacifier and the end, where the teething ring includes angular sides to prevent the double ended infant soothing device form rolling over a surface.

2. The double ended infant soothing device according to claim 1, where the cover includes a set of indentions for an ergonomic grip within the infant's hand.

3. The double ended infant soothing device according to claim 1, where the nipple is elongated.

4. The double ended infant soothing device according to claim 1, where the nipple is covered with a plurality of textured bumps.

5. The double ended infant soothing device according to claim 1, where the pacifier screws onto the end of the handle.

6. The double ended infant soothing device according to claim 1, where the pacifier snaps onto the end of the handle.

7. The double ended infant soothing device according to claim 1, where the teething rings include a range of sides from 3-10.

8. The double ended infant soothing device according to claim 1, where up to four teething rings are attached at each end of the handle.

9. The double ended infant soothing device according to claim 1, where the teething ring is liquid filled to allow the teething ring to be frozen.

10. The double ended infant soothing device according to claim 1, where the device is made from a material that is scented.

11. The double ended infant soothing device according to claim 1, where the device is made from a material that is flavored.
